(19) United States
(12) Patent Application Publication
(10) Pub. No.: US 2007/0180393 A1
(43) Pub. Date: Aug. 2, 2007

(54) Hierarchy modification tool

(76) Inventors: Klaus Dagenbach, Lampertheim (FR); Joachim Sander, Mannheim (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/340,489

(22) Filed: Jan. 27, 2006

(51) Int. Cl. G06F 9/00

(52) U.S. Cl. 715/769; 715/853; 715/854; 715/770

(57) ABSTRACT

Systems and methods are provided for personalizing a display of information. In one implementation, a method is provided that includes displaying information in a hierarchical form with a top level and a plurality of lower levels, receiving an input from an individual identifying a node from one of the lower levels, modifying a personal list for the individual to include the identified node, and displaying the nodes in the personal list at the top level of a display hierarchy.

### TECHNICAL FIELD

The present invention generally relates to systems and methods for displaying a hierarchical data structure and, more particularly, to systems and methods for personalizing the display of the hierarchical data structure.

### DESCRIPTION OF THE RELATED ART

Organizations often store organizational information in a hierarchical data structure for easy management and administration. For example, they may place names of departments at a top level, names of project groups within a department at a second level, etc. This presentation of data makes it easy to understand communication flows and responsibilities.

In many organizations, however, the data is dynamic, so the organization may place the information on intranet websites to give employees access to the most recent information. Employees may thus access the website for information related to departments and projects. In addition, for example, sales department director may post or update sales information through the website, or a human resources personnel may provide benefits information on the website, etc.

Unfortunately, conventional systems display the information in a hierarchical structure. Thus, when an individual logs onto the website, the same top level of the information hierarchy is presented at the top level of the display hierarchy. The individual must then select the department of interest by clicking a link to that department, and then can access second level information in the information hierarchy related to that department. The individual must follow the links through each level of the display hierarchy, and therefore the information hierarchy, to find the information needed. FIG. 1 shows an example of a hierarchical display of organizational information, and particularly financial information of product sales and post-sale services. The hierarchy shown in FIG. 1 includes one node at the top level, i.e., “Akron Heating Technologies,” one node at the second level, i.e., “40000 Sales, Marketing & Services,” three nodes at the third level, i.e., “41000 Sales,” “45000 Service,” and “46000 Marketing.” Under the node “45000 Service,” there are two nodes at the fourth level, i.e., “45100 Spare Parts” and “45300 Customer Service.” Under the node “45300 Customer Service,” there are further two nodes at the fifth level. For illustrative convenience, it may be said that node “40000 Sales, Marketing & Services” is the parent node of its child nodes “41000 Sales,” “45000 Service,” and “46000 Marketing,” the node “45000 Service” is the parent node of its child nodes “45100 Spare Parts” and “45300 Customer Service,” etc.

The above-described presentation of the hierarchical organizational information is inconvenient, because an individual who regularly needs information at a lower level must always traverse the higher levels of the hierarchy. For example, in the example of FIG. 1, a sales person who wants to access information for “45000 Customer Service” needs to click through the links from the top level to the fourth level.

### SUMMARY

A method of personalizing a display of information, consistent with the invention, includes displaying information in a hierarchical form with a top level and a plurality of lower levels, receiving an input from an individual identifying a node from one of the lower levels, modifying a personal list for the individual to include the identified node, and displaying the nodes in the personal list at the top level of a display hierarchy.

A computer-readable medium, consistent with the invention, contains a program for causing a processor to perform a method of personalizing a display of information. The method includes displaying information in a hierarchical form with a top level and a plurality of lower levels, receiving an input from an individual identifying a node from one of the lower levels, modifying a personal list for the individual to include the identified node, and displaying the nodes in the personal list at the top level of a display hierarchy.

A computer system, consistent with the invention, includes a processor and means for accessing a computer-readable medium containing a program for causing the processor to perform a method of personalizing a display of information. The method includes displaying information in a hierarchical form with a top level and a plurality of lower levels, receiving an input from an individual identifying a node from one of the lower levels, modifying a personal list for the individual to include the identified node, and displaying the nodes in the personal list at the top level of a display hierarchy.

Additional features and advantages of the invention appear in the following description and will be obvious from the description, or may be learned by practicing the invention. The foregoing background and summary are not intended to be comprehensive, but instead serve to help one skilled in the art understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 shows an example of a conventional hierarchical display of organizational information;

FIG. 2 is a flow chart showing a method consistent with the present invention for an individual to personalize a display of hierarchical information;

FIG. 3 shows a webpage containing the information in FIG. 1 personalized by a method consistent with the present invention;

FIG. 4 shows a computer system for implementing methods consistent with the present invention; and

FIG. 5 shows another computer system for implementing methods consistent with the present invention.

### DETAILED DESCRIPTION OF THE EMBODIMENTS

The following description refers to the accompanying drawings, in which, in the absence of a contrary representation, the same numbers in different drawings represent similar elements. The following implementations do not represent all implementations consistent with the claimed invention. Instead, they are merely examples. Other implementations, and modifications of the described implementations, may also fall within the scope of present invention.

A method for presenting organizational information consistent with the present invention allows individuals to personalize the display of the hierarchical organizational information. In the following discussion, the hierarchical structure of the information is referred to as the “information hierarchy,” and the hierarchical structure of the information displayed on webpages is referred to as the “display hierarchy.” In a hierarchical structure, there is usually a single root node at the highest level. Nodes at lower levels are reached through a node at next higher level.

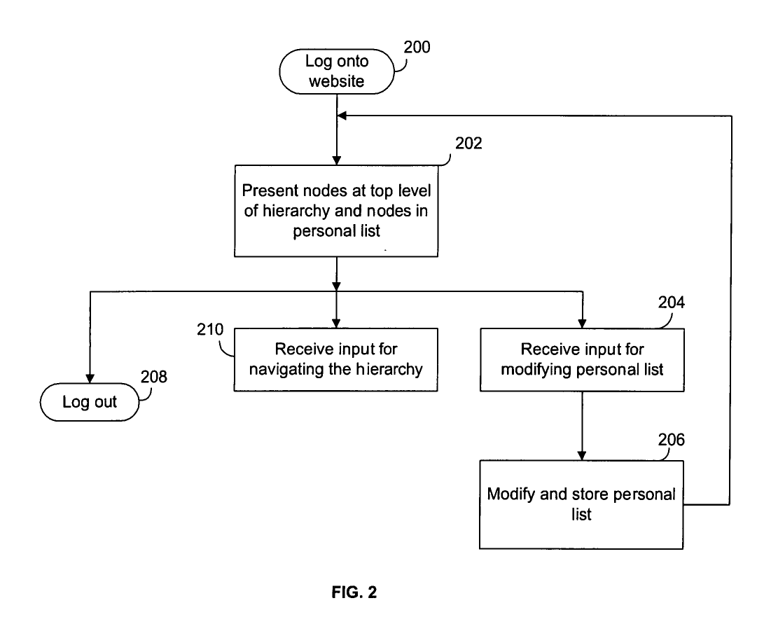

Consistent with the present invention, an individual can select nodes at lower levels of the information hierarchy that have particular interest, and place them in a personal list for display at the top level of the display hierarchy. This allows the individuals to have faster and more direct access to information of interest. The resulting display hierarchy for each individual will differ and better suits the needs of the individuals accessing the information. FIG. 2 shows a flow chart of a method consistent with the present invention allowing an individual to personalize a display of hierarchical information.

First, the individual logs onto a webpage containing a standard hierarchical display of information or, if it is personal, a personalized display. (Step 200.) If the display has been personalized, the nodes at the top level of the display hierarchy includes both the nodes at the top level of the information hierarchy and the nodes in the personal list. (Step 202.) If the individual wishes to modify the personal list, he provides an input for adding nodes or deleting nodes. (Step 204.) A processor responds to the input by modifying and saving the personal list (Step 206) and displaying the top level of the display hierarchy with including the nodes at the top level of the information hierarchy and the nodes in the updated personal list (Step 202). The individual may also choose to log off the webpage (Step 208) or navigate through the hierarchy (Step 210), before or after the personal list is modified. If, at Step 202, the personal list contains no node, then by modifying the personal list, new nodes may be added. The modification of the personal list at Steps 202 through 206 may be repeated as necessary to generate the desired personal list.

The personal list may be modified in many different ways. For example, an individual can go through the levels of the hierarchy to a lower level containing a node of interest and simply click and drag the node of interest into the personal list or away from the personal list. As another alternative, a webpage may contain a button for each node at a lower level of the hierarchy, where a click on the button adds the respective node to the personal list, and may also contain a button for each node in the personal list, where a click on the button removes the respective node from the personal list. Another example is a webpage containing a list of all the nodes of the hierarchy, where an individual logged onto the webpage may check the nodes to be placed in or removed from the personal list without going through the levels of the hierarchy. It is to be understood that these are only examples and the spirit of the invention is not limited thereto.

In one aspect, the nodes in a personal list may be excluded from the levels of the display hierarchy corresponding to their levels in the information hierarchy. Alternatively, nodes in the personal list may also be displayed at both the top level of the display hierarchy and the levels of display hierarchy corresponding to their levels in the information hierarchy. When a node is removed from the personal list, the node is displayed at the level of the display hierarchy corresponding to its level in the information hierarchy.

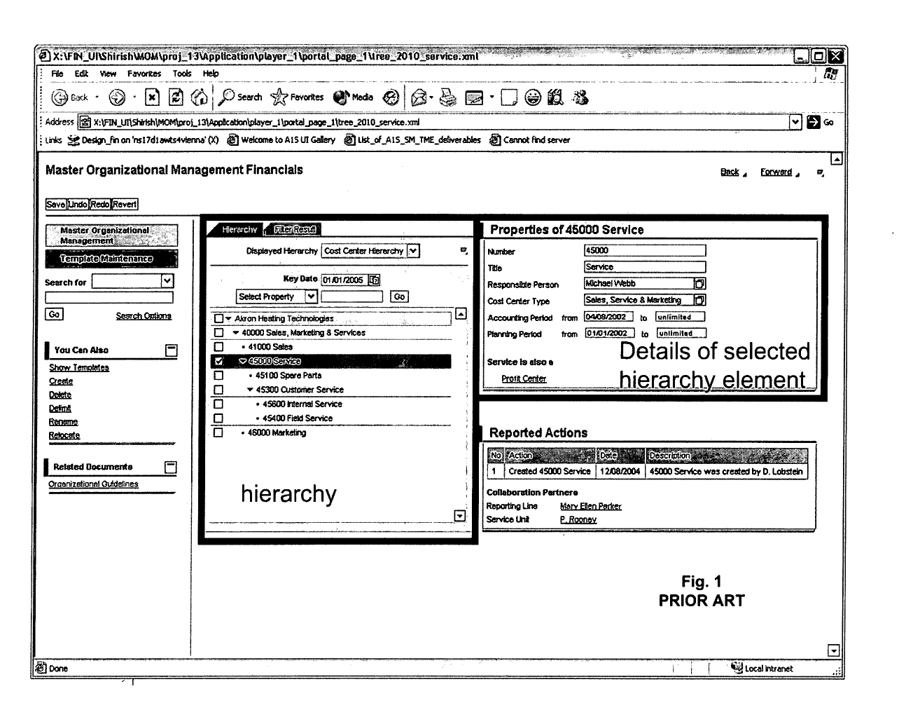

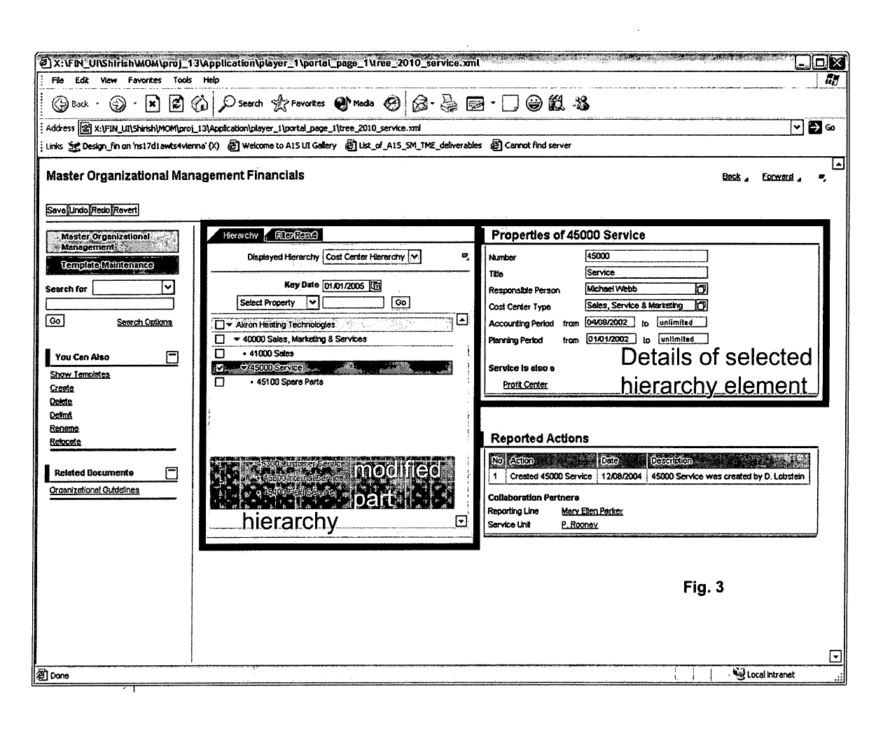

FIG. 3 shows the webpage of FIG. 1 after being personalized by the method of the present invention. As FIG. 3 shows, the top level of the display hierarchy now includes the nodes at the top level of the information hierarchy shown in the upper center portion of the webpage, and a personal list shown in the lower center portion. The personal list includes node “45300 Customer Service” and the two child nodes thereof and marked as “modified part.” The upper center portion shows the nodes at the top level of the information hierarchy and their child nodes, except those in the personal list. Note that in the example of FIG. 3, the nodes included in the personal list are not displayed again at the levels of the display hierarchy corresponding to their respective levels in the information hierarchy.

With the webpage personalized as shown in FIG. 3, the individual may now access “45300 Customer Service” directly when he logs onto the webpage, instead of going through the hierarchy into the fourth level each time. A different individual interested in other information may personalize the webpage in a different way so that the personal list includes such other nodes in his interest. Therefore, the method of the present invention allows easier access and management of hierarchical information through personalized display.

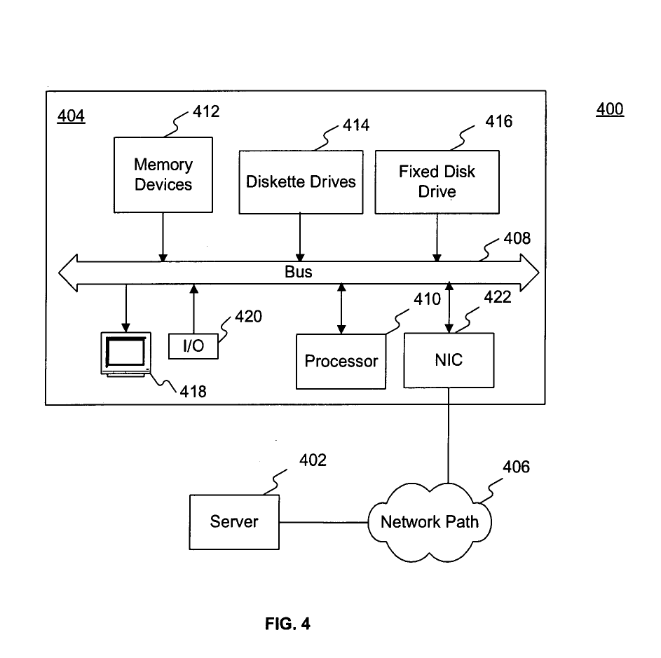

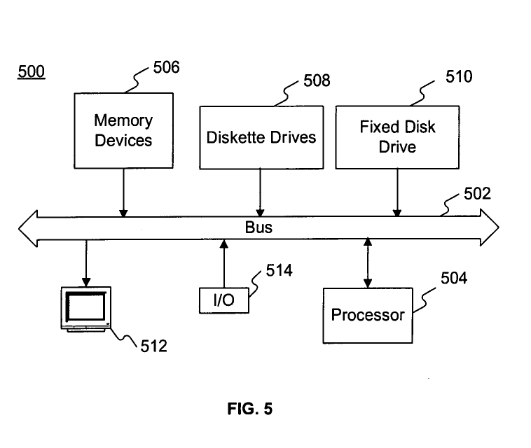

A computer system stores the hierarchical information and the personal lists and a software application implementing the method of the present invention. The hierarchical information is most often stored in a database installed on the computer system. The personal lists may also be stored in the database. The computer system may be a computer network, as shown in FIG. 4, or a stand-alone personal computer (PC), as shown in FIG. 5.

In FIG. 4, a computer network 400 for installing the software and the software application includes a server 402 and a stand-alone PC 404 connected through a network path 406. Computer network 400 may be a local area network (LAN), where server 402 and PC 404 are workstations. Computer network 400 may also be the Internet, with server 402 on the side of the client installing the database and PC 404 being any workstation available to an individual accessing the database. Alternatively, computer network 400 is a wide area network (WAN), and server 402 and PC 404 lie in two separate LANs connected through the Internet.

PC 404 includes a bus line 408 connecting a plurality of devices such as a processor 410, memory devices 412 for storage of information, diskette drives 414, a fixed disk drive 416, a monitor 418, other I/O devices 420, and a network interface card (NIC) 422. Processor 410 may be a microprocessor such as an Intel Pentium chip for processing applications. Memory devices 412 may include read-only memories (ROM) and/or random access memories (RAM). Diskette drives 414 may include a floppy drive and/or a compact disk (CD) drive. Fixed disk drive 416 may be a hard drive. Monitor 3418 displays the output from processor 410, and may also echo the input of the user. I/O devices 420 may include a keyboard and/or a mouse for receiving input from a user of PC 404. PC 404 is connected to network path 406 through NIC 422.

The database storing the hierarchical information and the personal lists is installed in server 402. An individual accessing the hierarchical information accesses and communicates with PC 404, which further communicates with server 402 through NIC 422 and network path 406. In one aspect, the software application implementing the method of the present invention is stored in PC 404 and processor 410 of PC 404 executes the software application locally within PC 404. Particularly, the software application may be stored on a floppy disk or a CD accessible by diskette drive 414 or on fixed disk drive 416. In another aspect, the software application implementing the method consistent with the present invention is stored in server 402, which executes the software application, and processor 410 of PC 404 communicates with server 402 to send information to server 402 and retrieve the results of the execution of the software application from server 402. A software application, stored either locally in PC 404 or remotely within server 402, may access the hierarchical information in server 402.

Alternatively, a stand-alone PC 500 shown in FIG. 5 may be used for implementing the method consistent with the present invention. PC 500 includes a bus line 502 connecting a plurality of devices such as a processor 504, memory devices 506 for storage of information, diskette drives 508, a fixed disk drive 510, a monitor 512, and other I/O devices 514. Processor 504 may be a microprocessor such as an Intel Pentium chip for processing applications. Memory devices 506 may include ROM and/or RAM. Diskette drives 508 may include a floppy drive and/or a compact disk (CD) drive. Fixed disk drive 510 may be a hard drive. Monitor 512 displays the output of processor 504 and may also echo the input of the user. I/O devices 514 may include a keyboard and/or a mouse for receiving input from a user of PC 500.

The database and the software application implementing the method consistent with the present invention may be stored together or separately on a floppy disk or a CD accessible by diskette drive 508 or on fixed disk drive 510. Processor 504 executes the software application stored in the floppy disk, the CD, or the fixed disk drive 510. An individual, through monitor 512 and I/O devices 514, interacts with processor 504, which executes the software application, thereby accessing the hierarchical information stored in the database.

The foregoing description of possible implementations consistent with the present invention does not represent a comprehensive list of all such implementations or all variations of the implementations described. The description of only some implementations should not be construed as an intent to exclude other implementations. One skilled in the art will understand how to implement the invention in the appended claims in may other ways, using equivalents and alternatives that do not depart from the scope of the following claims. Moreover, unless indicated to the contrary in the preceding description, none of the components described in the implementations is essential to the invention.

What is claimed is:

1. A method of personalizing a display of information, comprising:
displaying information in a hierarchical form with a top level and a plurality of lower levels;
receiving an input from an individual identifying a node from one of the lower levels;
modifying a personal list for the individual to include the identified node; and
displaying the nodes in the personal list at the top level of a display hierarchy.

2. The method of claim 1, wherein displaying the nodes in the personal list comprises only displaying the nodes in the personal list at the top level of the display hierarchy.

3. The method of claim 1, wherein displaying the nodes in the personal list comprises displaying the nodes in the personal list at the top level of the display hierarchy and at the levels from which the nodes were identified.

4. The method of claim 1, further comprising displaying nodes in a lower level, wherein the input identifying a node comprises dragging the node by the individual into the personal list.

5. The method of claim 1, further comprising displaying a button for each node in a lower level, wherein the input identifying a node comprises a click on the button by the individual.

6. The method of claim 1, further comprising displaying all nodes of the lower levels, wherein the input identifying a node comprises dragging the node by the individual into the personal list.

7. The method of claim 1, further comprising
receiving an input from the individual identifying a node in the personal list; and
removing the identified node from the personal list.

8. The method of claim 1, further comprising storing the personal list.

9. A computer-readable medium containing a program for causing a processor to perform a method of personalizing a display of information, the method comprising:
displaying information in a hierarchical form with a top level and a plurality of lower levels;
receiving an input from an individual identifying a node from one of the lower levels;
modifying a personal list for the individual to include the identified node; and
displaying the nodes in the personal list at the top level of a display hierarchy.

10. The computer-readable medium of claim 9, wherein displaying the nodes in the personal list comprises only displaying the nodes in the personal list at the top level of the display hierarchy.

11. The computer-readable medium of claim 9, wherein displaying the nodes in the personal list comprises displaying the nodes in the personal list at the top level of the display hierarchy and at the levels from which the nodes were identified.

12. The computer-readable medium of claim 9, the method further comprising displaying nodes in a lower level, wherein the input identifying a node comprises dragging the node by the individual into the personal list.

13. The computer-readable medium of claim 9, the method further comprising displaying a button for each node in a lower level, wherein the input identifying a node comprises a click on the button by the individual.

14. The computer-readable medium of claim 9, the method further comprising displaying all nodes of the lower levels, wherein the input identifying a node comprises dragging the node by the individual into the personal list.

15. The computer-readable medium of claim 9, the method further comprising
receiving an input from the individual identifying a node in the personal list; and
removing the identified node from the personal list.

16. The computer-readable medium of claim 9, the method further comprising storing the personal list.

17. A computer system, comprising:
a processor; and
means for accessing a computer-readable medium containing a program for causing the processor to perform a method of personalizing a display of information, the method comprising
displaying information in a hierarchical form with a top level and a plurality of lower levels;
receiving an input from an individual identifying a node from one of the lower levels;
modifying a personal list for the individual to include the identified node; and
displaying the nodes in the personal list at the top level of a display hierarchy.

18. The computer system of claim 17, wherein displaying the nodes in the personal list comprises only displaying the nodes in the personal list at the top level of the display hierarchy.

19. The computer system of claim 17, wherein displaying the nodes in the personal list comprises displaying the nodes in the personal list at the top level of the display hierarchy and at the levels from which the nodes were identified.

20. The computer system of claim 17, the method further comprising displaying nodes in a lower level, wherein the input identifying a node comprises dragging the node by the individual into the personal list.

21. The computer system of claim 17, the method further comprising displaying a button for each node in a lower level, wherein the input identifying a node comprises a click on the button by the individual.

22. The computer system of claim 17, the method further comprising displaying all nodes of the lower levels, wherein the input identifying a node comprises dragging the node by the individual into the personal list.

23. The computer system of claim 17, the method further comprising
receiving an input from the individual identifying a node in the personal list; and
removing the identified node from the personal list.

24. The computer system of claim 17, the method further comprising storing the personal list.

25. The computer system of claim 17, wherein the medium is a hard disk, a floppy disk, or a compact disk.

26. The computer system of claim 17, the computer system being a standalone computer.

27. The computer system of claim 17, the computer system being a computer network, wherein the processor and the means for accessing the computer-readable medium are both located in a computer used by the individual to access the computer network.

28. The computer system of claim 17, the computer system being a computer network, wherein the means for accessing the computer-readable medium is located in a computer used by the individual to access the computer network and the processor is located in a server of the computer network.

29. The computer system of claim 17, the computer system being a computer network, wherein the information and the personal list are stored in a server of the computer network.
